(19) United States
(12) Patent Application Publication
(10) Pub. No.: US 2010/0046105 A1
(43) Pub. Date: Feb. 25, 2010

(54) Optical Sheet For High Resolution, Filter Comprising The Same, And Display Device Having The Sheet Or The Filter

(75) Inventors: Jong-Pil Chun, Daejeon-City (KR); Bu Seup Song, Daejeon-City (KR); Ki Chul Yoon, Cheonan-City (KR); Woo Ju Jeong, Daejeon-City (KR)

Correspondence Address: Nixon Peabody LLP, P.O. Box 60610, Palo Alto, CA, 94306, US

(73) Assignee: SAMSUNG FINE CHEMICALS CO., LTD, Ulsan-city (KR)

(21) Appl. No.: 12/594,582

(22) PCT Filed: Mar. 25, 2008
(86) PCT No.: PCT/KR2008/001661

§ 371 Date: Oct. 2, 2009

(30) Foreign Application Priority Data
Apr. 4, 2007 (KR) 10-2007-0033150

(51) Int. Cl. G02B 5/22

(52) U.S. Cl. 359/891

(57) ABSTRACT

Provided are an optical sheet for high resolution, a filter comprising the same, and a display device having the optical sheet for high resolution or the filter. The optical sheet for high resolution includes: a plurality of external light absorption units that are disposed separate from each other at a predetermined interval and comprise a light absorbing material; a plurality of light transmission units optically separated from each other by the external light absorption units, wherein the refractive index of the light transmission unit is smaller than the refractive index of the external light absorption unit. Thus, the optical sheet for high resolution, the filter comprising the same, and the display device having the optical sheet for high resolution or the filter can maintain high resolution by reducing generation of ghost images and moiré phenomenon and improving the contrast ratio.

### TECHNICAL FIELD

The present invention relates to an optical sheet for high resolution, a filter comprising the same, and a display device having the optical sheet for high resolution or the filter, and more particularly, to an optical sheet for high resolution which can maintain high resolution by reducing ghost and moiré phenomena and improving a contrast ratio, a filter comprising the same, and a display device having the optical sheet for high resolution or the filter.

### BACKGROUND ART

Recently, various types of image display devices have been developed and used in a practical use. Examples of image display devices include liquid crystal displays (LCDs), plasma display panels (PDPs), field emission displays (FEDs), cathode ray tubes (CRTs), vacuum fluorescence displays, and field emission display panels. These image display devices realize emission of three primary lights such as red, blue, and green, thereby displaying color images.

Such image display devices include a panel assembly that forms images and a filter that blocks an electromagnetic wave, near-infrared ray, and/or orange light emitted from the panel assembly and has functions such as surface reflection prevention and/or color adjustment. The filter is disposed on a front side of the panel assembly, and thus the filter should meet the requirement for light transmittance.

However, in conventional image display devices, external environmental light pass through a filter and is introduced into a panel assembly in outside bright conditions, that is, in a bright room. In this case, incident light emitted from the panel assembly overlaps with the external environmental light introduced from the outside via the filter. Due to this, the contrast ratio in a bright room is decreased, and thus image display capability of an image display device deteriorates. To address those problems, Japanese Patent Laid-open Publication No. 2005-338270 discloses a viewing angle control sheet. That is, the viewing angle control sheet has a structure in which external light absorption units that have a wedge shape and include a black light absorbing material are disposed at a predetermined interval in contact with a transparent light transmission unit. In addition, by filling the external light absorption units with a material having a smaller refractive index than that of the light transmission unit and a light absorbing material, an image light incident on the external light absorption unit in an inclined direction can more effectively reach observers by total reflection, resulting in improvement in transmittance. However, there is still a limitation that light emitted from the image light source and totally reflected is reflection-diffused and/or scattered in a filter of an image display device, and external light that is not fully absorbed into the external light absorption unit overlaps with the image light, resulting in generation of ghost images.

In addition, in the case of conventional image display devices, moiré phenomenon occurs due to interference between periodic patterns of cells forming pixels and a filter. As a result, image display capability of the image display device deteriorates.

### DISCLOSURE OF INVENTION

### Technical Problem

The present invention provides an optical sheet for high resolution that can improve a contrast ratio in bright room and reduce the formation of ghost images.

The present invention also provides an optical sheet for high resolution that can prevent moiré phenomenon.

The present invention also provides a filter including the optical sheet for high resolution.

The present invention also provides a display device with improved resolution and no moire phenomenon, by including the optical sheet for high resolution or the filter.

### Technical Solution

According to an aspect of the present invention, there is provided an optical sheet for high resolution comprising: a plurality of external light absorption units that are disposed separately from each other at a predetermined interval and comprise a light absorbing material; and a plurality of light transmission units optically separated from each other by the external light absorption units, wherein the refractive index of the light transmission unit is smaller than the refractive index of the external light absorption unit.

According to an aspect of the present invention, there is provided a filter for a display device, comprising: a plurality of external light absorption units that are disposed separately from each other at a predetermined interval and comprise a light absorbing material; a plurality of light transmission units optically separated from each other by the external light absorption units; and a filter base, wherein the refractive index of the light transmission unit is smaller than the refractive index of the external light absorption unit.

The external light absorption unit may be disposed in a stripe form, matrix form, or wave form.

The external light absorption unit may have a polygonal cross-section that simultaneously satisfies the following conditions:

0.5 H_{R}≦H₂₂₀≦0.95 H_{R} 1)

0.1 Wₚ≦W₂₂₀≦0.4Wₚ 2)

50 μm≦H_{R}−Wₚ≦160 μm 3)

50 μm≦Wₚ≦200 μm 4)

where H₂₂₀ refers to the height of the external light absorption unit, W₂₂₀ refers to the width of one end of the external light absorption unit, H_{R} refers to the thickness of the light transmission unit, and Wₚ refers to a pitch of the light transmission unit.

The external light absorption unit may have a trapezoidal cross-section that additionally satisfies the following condition:

0.15≦W′₂₂₀/W₂₂₀≦1.5 5)

where W₂₂₀ and W′₂₂₀ respectively refers to the widths of one end and the other end of the external light absorption unit.

When the cross-section of the external light absorption unit is outside the ranges, the absorption rate and transmittance are significantly decreased or increased, resulting in poor visibility.

The external light absorption unit may have a trapezoidal cross-section that additionally satisfies the following condition:

0.15≦W′₂₂₀/W₂₂₀≦0.35 5)

where W₂₂₀ and W′₂₂₀ respectively refers to the widths of one end and the other end of the external light absorption unit.

When the external light absorption unit is prepared to have a trapezoidal cross-section, it should satisfy the conditions described above in order to simultaneously achieve a viewing angle and appropriate resolution.

The external light absorption unit may have a pentagonal cross-section that additionally satisfies the following condition:

2.0≦W_{220.max}/W₂₂₀≦3.0 5′)

where W₂₂₀ and W_{220.max} respectively refers to the width of one end of the external light absorption unit and the maximum width of the external light absorption unit.

When the external light absorption unit is prepared to have a pentagonal cross-section, it should satisfy the conditions described above in order to retain an external light absorption rate and effectively transmit an image light.

The optical sheet for high resolution or the filter for a display device may further comprise a prism unit disposed on an image light source side.

The optical sheet for high resolution may further comprise a protection film disposed on an observer side.

The filter base may comprise a reflection prevention film, a hard coating layer, an electromagnetic blocking film, or a combined layer thereof.

The filter for a display device may further comprise a color adjustment film disposed on an image light source side.

A longitudinal direction of the external light absorption unit may not be parallel to a side of the optical sheet for high resolution, and a bias angle α greater than 0° exists therebetween. The term ‘longitudinal direction’ used herein refers to a longitudinal direction of the stripe when the external light absorption unit is in a stripe form, refers to a straight line direction connecting a portion of each constitutional element of the matrix to the corresponding portion thereof when the external light absorption unit is in a matrix form, and refers to a straight line direction connecting a portion of each wave cycle to the corresponding portion thereof when the external light absorption unit is in a wave form.

According to another aspect of the present invention, there is provided a display device comprising the optical sheet for high resolution or the filter for a display device, according to any one of the embodiments of the present invention.

### Advantageous Effects

### DESCRIPTION OF DRAWINGS

The above and other features and advantages of the present invention will become more apparent by describing in detail exemplary embodiments thereof with reference to the attached drawings in which:

FIG. 1 is an exploded perspective view schematically illustrating a stricture of a display device equipped with a filter including an optical sheet for high resolution, according to an embodiment of the present invention;

FIG. 2 is an exploded cross-sectional view of a filter including an optical sheet for high resolution, according to an embodiment of the present invention;

FIG. 3 is a cross-sectional view of an optical sheet for high resolution according to an embodiment of the present invention;

FIG. 4 is an enlarged view of portion A of FIG. 3;

FIG. 5 is a cross-sectional view of an optical sheet for high resolution awarding to another embodiment of the present invention;

FIG. 6 is a cross-sectional view of an optical sheet for high resolution warding to another embodiment of the present invention;

FIG. 7 is a cross-sectional view of an optical sheet for high resolution according to another embodiment of the present invention;

FIG. 8 is images showing simulation results of a degree of generation of ghost images in the optical sheet for high resolution of FIG. 4, according to a difference in refractive indexes of a light transmission unit and external light absorption unit of the optical sheet for high resolution and an incidence angle of light;

FIG. 9 is a schematic view for explaining an experiment method for obtaining the simulation results of FIG. 8;

FIG. 10 is a partial exploded perspective view of a modification example of the optical sheet for high resolution of FIG. 3 that is designed for preventing moiré phenomenon;

FIG. 11 is a partial exploded perspective view of another modification example of the optical sheet for high resolution of FIG. 3 that is designed for preventing moiré phenomenon; and

FIG. 12 is a partial exploded perspective view of another modification example of the optical sheet for high resolution of FIG. 3 that is designed for preventing moiré phenomenon.

### BEST MODE

The present invention will now be described more specifically with reference to the accompanying drawings, in which exemplary embodiments of the invention are shown.

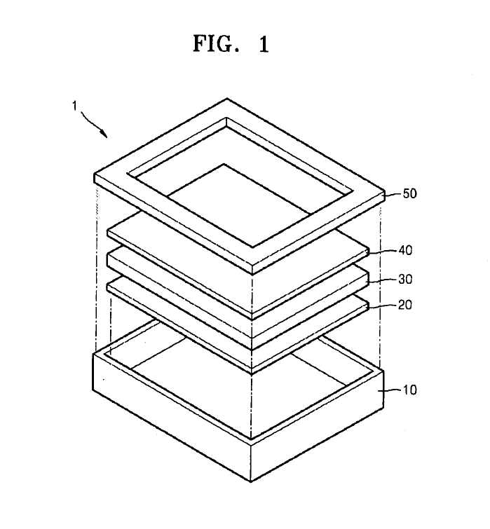

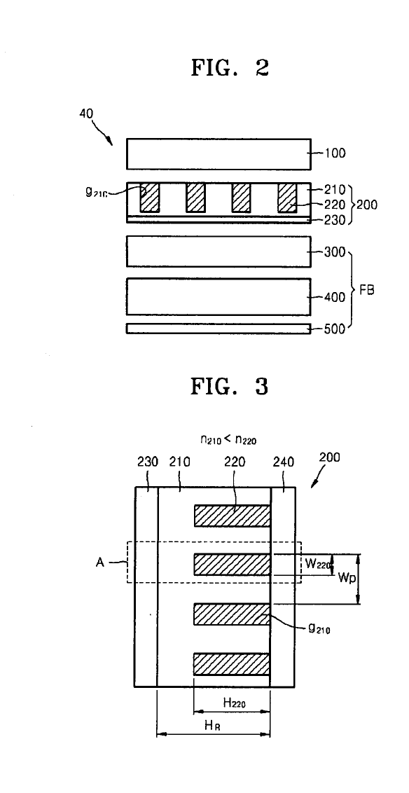

FIG. 1 is an exploded perspective view schematically illustrating a stricture of a display device equipped with a filter including an optical sheet for high resolution, according to an embodiment of the present invention. FIG. 2 is an exploded cross-sectional view of a filter including an optical sheet for high resolution, according to an embodiment of the present invention.

Referring to FIG. 1, a display device 1 according to the current embodiment of the present invention includes a case 10, a cover 50 covering a top portion of the case 10, a driving circuit substrate 20 a accommodated in the case 10, a panel assembly 30 that forms images, and a filter 40.

Visible images formed in the panel assembly 30 by an electrical signal applied from the driving circuit substrate 20 are displayed to the outside via the filter 40.

The filter 40 includes, as illustrated in FIG. 2, a color adjustment film 100, an optical sheet for high resolution 200, and a filter base (FB) including a reflection prevention film 500.

The color adjustment film 100 primarily includes, for example, a neon light blocking colorant, and may also include a near-infrared ray absorption compound or a colorant.

The neon light blacking colorant included in the color adjustment film 100 may be a compound such as cyanines, squaryliums, azomethines, xanthenes, oxonols, or azos. Herein, neon light refers to unnecessary light at around a wavelength of 585 nm, generated as a neon gas is excited.

When the color adjustment film 100 includes the near-infrared ray absorption compound, the compound may be a copper atom-containing resin, a copper or phosphorus compound-containing resin, a copper compound or thiourea derivative-containing resin, or a tungsten-based compound-containing resin. Herein, near-infrared rays cause a malfunction of ambient electronic devices, and thus the near-infrared rays need to be blocked.

The optical sheet for high resolution 200 includes a light transmission unit 210 and an external light absorption unit 220 formed on a base film 230, and is disposed below the color adjustment film 100.

The light transmission unit 210 transmits light emitted from the panel assembly 30 illustrated in FIG. 1. The light transmission unit 210 may be formed of a cured-type resin. In particular, the light transmission unit 210 may be formed of an acrylate or urethane resin cured by ionizing radiation or heat energy.

In addition, the light transmission unit 210 may be transparent, but it does not mean that the light transmission unit 210 is completely transparent, and may have transparency generally acceptable in the art. The light transmission unit 210 generally may have a shape complementary to the shape of the external light absorption unit 220, which will be described later, but the present invention is not limited thereto. The light transmission unit 210 may have a refractive index (n₂₁₀) of 1.33 to 1.6. When the refractive index of the light transmission unit 210 is less than 1.33, it is difficult to manufacture the light transmission unit 210. When the refractive index of the light transmission unit 210 is greater than 1.6, the transmittance of the light transmission unit 210 is significantly decreased and the contrast ratio is also decreased, resulting in a decrease in overall resolution.

The external light absorption unit 220 is formed by filling a light absorbing material in grooves g₂₁₀ disposed in the light transmission unit 210, wherein each of the grooves being separated from each other at a predetermined interval. The external light absorption unit 220 absorbs external environmental light, and thus improves a contrast ratio in bright room, and ultimately remains high resolution. However, the present invention is not limited to embodiments of FIGS. 3 through 7 that will be described later. That is, the light transmission unit 210 may be in a flat-plate form without including grooves therein, and the external light absorption unit 220 may be disposed on one surface of the light transmission unit 210, that is, the surface facing the color adjustment film 100. The external light absorption unit 220 may be formed of a material capable of absorbing light, for example, a black inorganic material, a black organic material, and/or a black-oxidized metal. The black-oxidized metal has a low electrical resistance. Thus, when the external light absorption unit 220 is formed of the black-oxidized metal, the electrical resistance can be adjusted by adjusting the amount or thickness of metal powder. Therefore, the external light absorption unit 220 can also block electromagnetic waves. The external light absorption unit 220 may be primarily formed of an ultra violet ray cured type resin containing carbon. The refractive index n 220 of the external light absorption unit 220 may be in a range of 1.33 to 1.6, similar to that of the light transmission unit 210.

The base film 230 is disposed on one surface of the light transmission unit 210, that is, the surface opposite to the external light absorption unit 220. The base film 230 supports the light transmission unit 210 with the external light absorption unit 220 formed therein. The base film 230 may be formed of a cured-type resin. In particular, examples of the base film 230 may include at least one material selected from the group consisting of polyethersulphone (PES), polyarylate (PAR), polyetherimide (PEI), polyethyelene naphthalate (PEN), polyethyleneterephthalate (PET,), poly-phenylene sulfide (PPS), polyallylate, polyimide, polycarbonate (PC), cellulose triacetate (TAC), and cellulose acetate propionate (CAP). Preferably, the base film 230 may be formed of polycarbonate (PC), polyethyeleneterephthalate (PET), cellulose triacetate (TAC), or polyethyelene naphthalate (PEN). In addition, the base film 230 may be formed of a material having a refractive index the same as or similar to the refractive index of the light transmission unit 210.

In addition, the optical sheet for high resolution 200 according to the current embodiment of the present invention may further include a protection film 240, as illustrated in FIGS. 3 through 7 that will be described later, formed on one surface of the light transmission unit 210, that is, the surface opposite to the base film 230. The protection film 240 protects the optical sheet for high resolution 200 until the optical sheet for high resolution 200 is installed in the filter 40, and when the optical sheet for high resolution 200 is installed in the filter 40, the protection film 240 is separated from the optical sheet for high resolution 200.

An adhesive layer like a pressure sensitive adhesive (PVA) layer (not shown) may be disposed between the light transmission unit 210 and the protection film 240. In addition, another adhesive layer may be disposed on the surface of the base film 230 to make the optical sheet for high resolution 200 attach to another sheet like a electromagnetic wave blocking film 300.

In FIG. 2, the filter base (FB) is disposed on one side of the optical sheet for high resolution 200, and includes an electromagnetic wave blocking film 300, a hard coating layer 400, and a reflection prevention film 500. However, the present invention is not limited to the configuration described above. The deposition order of the three layers 300, 400 and 500 in the FB may variously vary, and the FB may be formed of a single layer or two layers by adding two or three different materials having different functions each other to a layer.

The electromagnetic wave blocking film 300 blocks electromagnetic waves. The electromagnetic wave blocking film 300 may have various structures, such as a single structure of a conductive mesh layer, a metal thin film, or a high-refractive-index transparent thin film, or a laminated structure of at least two layers thereof. In FIG. 2, the electromagnetic wave blocking film 300 is in a single-layer form. However, the present invention is not limited to the example described above, and the electromagnetic wave blocking film 300 may be formed as a multiple layer including at least two layers.

The hard coating layer 400 has resistance to scratching, thus preventing the electromagnetic wave blacking film 300 or the reflection prevention film 500 that will be described later from being damaged by contact with outside materials. The hard coating layer 400 may be a reinforced glass itself, or may be a reinforced glass including polymer as a binder. In addition, the hard coating layer 400 may be formed including an acryl-based, urethane-based, epoxy-based, or siloxane-based polymer, and may be formed including an ultraviolet curing resin such as oligomer. Further, to improve the hardness of the hard coating layer 400, a silica-based filler may be added thereto.

The reflection prevention film 500 minimizes eye tiredness of users watching a display device for a long period of time by adjusting the transmittance of visible light. By adjusting the transmittance of visible light by installing the reflection prevention film 500, not only selective absorption effects of visible light but also widening effects of color reproduction ranges such as a contrast ratio can be obtained. In FIG. 2, the reflection prevention film 500 is in a single-layer form. However, the present invention is not limited to the example described above, and the reflection prevention film 500 may be formed as a multiple layer including at least two layers.

The reflection prevention film 500 has reflection prevention effects by a principle in which visible light that is incident from the outside and reflected from the surface of the reflection prevention film 500 and visible light reflected later from an interface between the reflection prevention film 500 and the hard mating layer 400 are out of phase from each other, and thus destructive interference occurs.

The reflection prevention film 500 may be formed by airing and fixing a mixture of indium tin oxide (ITO) and silicon oxide (SiO₃), a mixture of nickel chromate (NiCr) and silicon oxide (SiO₂), or the like. In addition, the reflection prevention film 500 may be formed of titanium oxide or a specific fluorine resin having a low refractive index.

Hereinafter, particular configuration and operation effects of the external light absorption unit 220 will be described more fully with reference to the accompanying drawings.

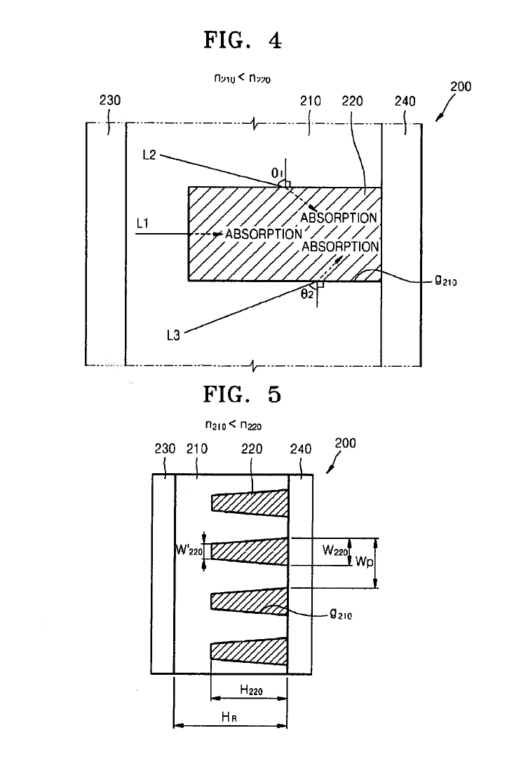

FIG. 3 is a cross-sectional view of an optical sheet for high resolution according to an embodiment of the present invention. FIG. 4 is an enlarged view of portion A of FIG. 3.

The external light absorption unit 220 may be formed by roll forming, thermal pressing using a thermoplastic resin, or injection molding performed by filling a thermoplastic or thermosetting resin in the light transmission unit 210 in which grooves g₂₁₀ having a shape opposite to the pattern of the external light absorption unit 220 are formed. In addition, when the ultra violet curing resin included in the light transmission unit 210 has a reflection prevention function, an electromagnetic wave blocking function, a color adjustment function, or a combined function thereof, the optical sheet for high resolution 200 can additionally performed these functions.

Referring to FIG. 3, the optical sheet for high resolution 200 according to the current embodiment of the present invention includes the light transmission unit 210, the external light absorption unit 220, the base film 230, and the protection film 240. Herein, the protection film 240 may be optionally omitted.

A relative disposition of the light transmission unit 210, the external light absorption unit 220, the base film 230, and the protection film 240 is the same as described above.

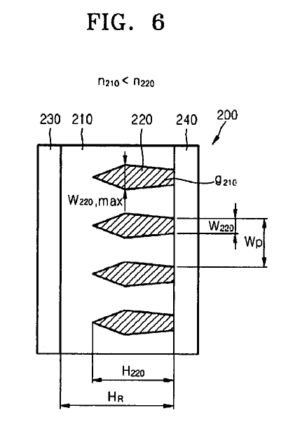

The external light absorption unit 220 may be disposed in various forms, such as stripe, matrix, wave, or the like. In addition, a plurality of external light absorption units 220 is disposed separate from each other at a predetermined interval in order to transmit light therebetween. In FIG. 3, the external light absorption unit 220 has a tetragonal cross-section. However, the present invention is not limited to the example described above, and the external light absorption unit 220 may have, as illustrated in FIGS. 5 and 6, a trapezoidal or pentagonal cross-section. Like reference numerals in FIG. 3 denote like elements or like portions of the elements in FIGS. 5 and 6.

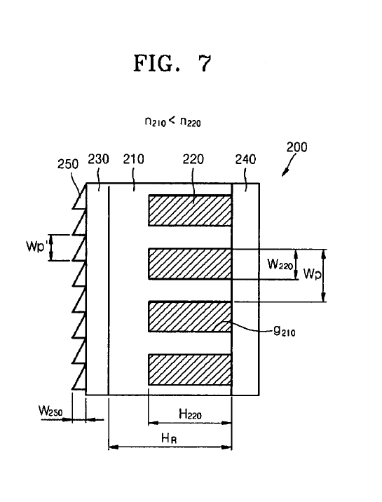

The optical sheet for high resolution 200 according to the embodiments of the present invention may further include, as illustrated in FIG. 7, a prism unit 250 disposed on one surface of the base film 230, that is, the surface opposite to the light transmission unit 210. The prism unit 250 may be formed of a material the same as or similar to the material of the light transmission unit 210. By including the prism unit 250 like this, the optical sheet for high resolution 200 can have improved external light absorption rate, increased contrast ratio, and improved resolution without a large variation in transmittance.

In the current embodiments, the refractive index n₂₂₀ of the external light absorption unit 220 is adjusted to be higher than the refractive index n₂₁₀ of the light transmission unit 210 (that is, n₂₁₀<n₂₂₀). A refractive index difference (Δn=n₂₁₀−n₂₂₀) between the light transmission unit 210 and the external light absorption unit 220 may be −0.05 or more and less than 0. Thus, the external light absorption rate of the optical sheet for high resolution 200 is increased, resulting in a reduction in formation of ghost images. Herein, the ghost images are generated in such a manner that the light emitted from the panel assembly 30 as described above overlaps with external environmental light that is not fully absorbed into the external light absorption unit 220 and reflected back to the outside. Therefore, users watching a display device realize an image as two overlapped images.

A principle of reducing or eliminating ghost images by adjusting the refractive index difference between the external light absorption unit 220 and the light transmission unit 210 will now be described more fully with reference to FIG. 4. Referring to FIG. 4, when external environmental lights L1, L2 and L3 incident from the outside are incident on the external light absorption unit 220, the lights L1, L2 and L3 are completely absorbed into the external light absorption unit 220 without being reflected from the interface between the light transmission unit 210 and the external light absorption unit 220, due to the refractive index difference

adjusted as described above, regardless of an incidence angle, that is, angles (0°, θ1, θ2) between the lights L1, L2, L3 and the normal of the interface between the light transmission unit 210 and the external light absorption unit 220. Thus, the external light absorption rate is increased, and the generation of ghost images is reduced, accordingly.

If the refractive index difference (Δn=n₂₁₀−n₂₂₀) between the light transmission unit 210 and the external light absorption unit 220 has a positive value unlike in the present invention, an image light which is incident on the interface between the light transmission unit 210 and the external light absorption unit 220 at an angle smaller than a critical angle is totally reflected. As a result, separate images different from the images generated by the panel assembly, that is, ghost images are formed.

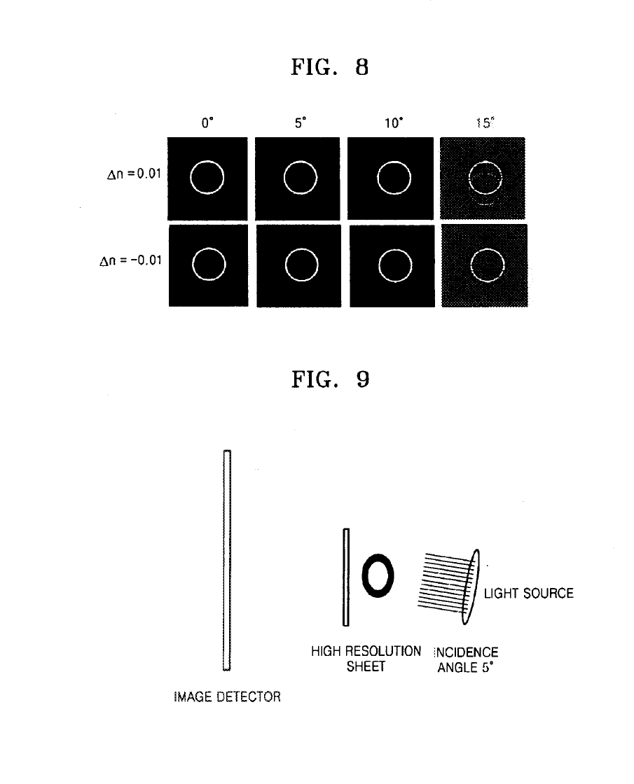

A degree of generation of the ghost images according to the refractive index difference between the light absorption unit 210 and the external light absorption unit 220 and a variation in an incidence angle θ of light emitted from a light source is shown in Table 1 below and FIG. 8. Herein, the term ‘light source’ does not refer to external environmental light, and is used as a concept corresponding to the light emitted from the panel assembly 30 of the display device 1. The degree of generation of the ghost images varies depending on viewing angles of observers, but with the viewing angles of observers unchanged, the degree of generation of the ghost images is simulated by varying incidence angles of light rays of light source. In addition, functional evaluation of the optical sheet for high resolution after being installed in a plasma display device is performed. The results are shown in Table 1 below.

TABLE 1
Degree of generation of ghost images according to refractive
index difference (Δn = n₂₁₀ − n₂₂₀) between light transmission
unit and external light absorption unit and incidence angle θ
of light (◯: Good, X: Bad)

| | Incidence angle of light (θ) | | | | |
|---|---|---|---|---|---|
| Δn | 0° | 5° | 10° | 15° | 20° |
| 0.05 | ◯ | ◯ | X | X | X |
| 0.02 | ◯ | ◯ | X | X | X |
| 0.01 | ◯ | ◯ | X | X | X |
| −0.01 | ◯ | ◯ | ◯ | ◯ | ◯ |
| −0.02 | ◯ | ◯ | ◯ | ◯ | ◯ |
| −0.05 | ◯ | ◯ | ◯ | ◯ | ◯ |

As can be seen in Table 1 and FIG. 8, when the incidence angle θ of light is 5° or less, the ghost images are not generated regardless of the refractive index difference (Δn==n₂₁₀−n₂₂₀). However, when the incidence angle θ of light is between 10 and 20°, the ghost images are not generated only when the refractive index difference is less than 0.

The simulation results in Table 1 and FIG. 8 will now be complimentarily described with reference to simulation results obtained by FIG. 9. That is, for example, when light is incident on the optical sheet for high resolution at an incidence angle of 5° as illustrated in FIG. 9, images are formed on an image detector and the images are displayed as in FIG. 8. From this, the degree of generation of the ghost images according to viewing angles of observers is indirectly measured.

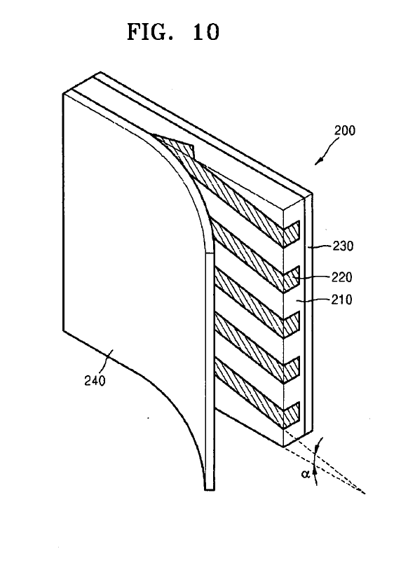

FIG. 10 is a partial exploded perspective view of a modification example of the optical sheet for high resolution of FIG. 3 that is designed for preventing moiré phenomenon. Herein, the moire phenomenon refers that when at least two periodic patterns overlap with each other, interference fringes are produced.

Referring to FIG. 10, a longitudinal direction of the external light absorption unit 220 is not parallel to a side of the optical sheet for high resolution 200, and a bias angle a greater than 0° exists therebetween. Although not illustrated in FIG. 10, the panel assembly 30 includes a plurality of cells that emit visible light forming images. The cells are disposed in a stripe form, matrix form, or wave form, and thus are disposed similarly to the external light absorption unit 220 of the optical sheet for high resolution 200. In this case, when the disposition direction of the external light absorption unit 220 is coincident with the disposition direction of the cells, both patterns overlap with each other, and thus moiré phenomenon occurs. By making the bias angle α between the longitudinal direction of the external light absorption unit 220 and a longer side of the light transmission unit 210 greater than 0°, both patterns are not coincident with each other when observed by users, thereby preventing moiré phenomenon. Preferably, the bias angle α may be in a range of 5 to 80°.

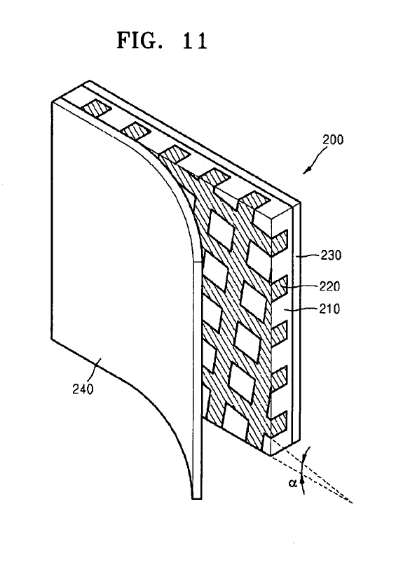

FIG. 11 is a partial exploded perspective view of another modification example of the optical sheet for high resolution of FIG. 3 that is designed for preventing moiré phenomenon. Like reference numerals in FIG. 10 denote like elements or like portions of the elements in FIG. 11.

The current embodiment is only different from the embodiment of FIG. 10 in that the external light absorption unit 220 is disposed in a matrix form, not in the stripe form.

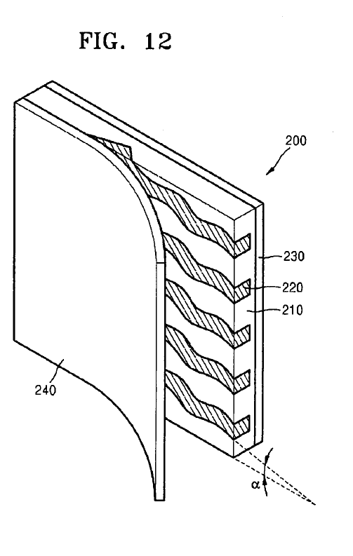

FIG. 12 is a partial exploded perspective view of another modification example of the optical sheet for high resolution of FIG. 3 that is designed for preventing moiré phenomenon. Like reference numerals in FIG. 11 denote like elements or like portions of the elements in FIG. 12.

The current embodiment is only different from the embodiment of FIG. 10 in that the external light absorption unit 220 is disposed in a wave form, not in the stripe form.

The optical sheet for high resolution having the configurations described above or the filter including the same may be included in a display device. Thus, double images of the display device can be decreased and the contrast ratio thereof can be increased, resulting in achievement of high resolution, and moiré phenomenon can be prevented.

### Mode for Invention

Hereinafter, the present invention will be described in further detail with reference to the following examples. These examples are for illustrative purposes only and are not intended to limit the scope of the present invention.

### Example

### Preparation of Optical Sheet for High Resolution

### Example 1

A molding roll with protrusions formed thereon, which were in a form opposite to a rectangular-shaped optical sheet for high resolution was manufactured. Then, by using a pattern roll equipped with an ultra violet device, with 100 g of an acryl-based curing resin mixed solution having a low refractive index being added slowly between the molding roll and a base film, that is, an optical PET film having a thickness of 188 μm (Toyobo company), the mixed solution was cured. As a result, a light transmission unit that had grooves having a shape transferred from the shape of the protrusions formed on the molding roll and had a refractive index of 1.48 was obtained. A carbon dispersion solution prepared by mixing 2 g of carbon black with 100 g of the acryl-based curing resin mixed solution was distributed in the transferred grooves. Then, the resulting structure was wiped several times using a doctor blade formed of soft plastic, and thus the grooves were uniformly filled with the carbon dispersion solution to complete a manufacture of an external light absorption unit having a refractive index of 1.49. Then, the resultant was Lured by ultra-violet rays to manufacture an optic sheet for high resolution as illustrated in FIG. 3. Herein, a pitch Wₚ of the light transmission unit 210 was 107.5 μm, the width W₂₂₀ and height H₂₂₀ of the external light absorption unit 220 was 24 μm and 160 μm, respectively, and the thickness H_{R} of the light transmission unit 210 was 200 μm.

### Example 2

An optical sheet for high resolution 200 of FIG. 5 was manufactured in the same manner as in Example 1, except that the external light absorption unit 220 was in a trapezoidal form, not in the rectangular torn.

Herein, the pitch Wₚ of the light transmission unit 210 was 107.5 μm, the width W₂₂₀ of one end of the external light absorption unit 220, that is, the length of a long line of the trapezoid was 33.5 μm, the width W′₂₂₀ of the other end of the external light absorption unit 220, that is, the length of a short line of the trapezoid was 8 μm, and the height H₂₂₀ of the external light absorption unit 220 was 160 μ. In addition, the thickness H_{R} of the light transmission unit 210 was 200 μm.

### Example 3

An optical sheet for high resolution 200 of FIG. 6 was manufactured in the same manner as in Example 1, except that the external light absorption unit 220 was in a pentagonal form, not in the rectangular form.

Herein, the pitch Wₚ of the light transmission unit 210 was 107.5 μm, the widths of the external light absorption unit 220, that is, the length W₂₂₀ of the shortest side of the pentagon and the maximum width W_{220.max} of the external light absorption unit 220 were 13.9 μm and 30.4 μm, respectively, and the height H₂₂₀ of the external light absorption unit 220 was 160 μm. In addition, the thickness H_{R} of the light transmission unit 210 was 200 μm.

### Example 4

An optical sheet for high resolution 200 of FIG. 7 was manufactured in the same manner as in Example 1, except that a prism unit 250 was formed on one surface of the base film 230, that is, the surface opposite to the external light absorption unit 220. A pitch Wₚ′ between the prism units 250 was 53.75 μm, and the thickness W₂₅₀ of the prism unit 250 was 10 μm.

### Comparative Example

An optical sheet for high resolution was manufactured in the same manner as in Example 1, except that the external light absorption unit was in a trapezoidal form, not in the rectangular form, the refractive index of the light transmission unit was 1.56, and the refractive index of the external light absorption unit was 1.55.

Transmittance Measurement Test

A transmittance measurement test was performed on the optical sheets for high resolution of Examples 1 through 4 and Comparative Example by using a UV-Vis Spectrometer. The results are shown in Table 2 below.

Ghost Image Evaluation

A degree of generation of ghost images in the optical sheets for high resolution of Examples 1 through 4 and Comparative Example was measured by functionally evaluating each of the plasma display devices including the optical sheets for high resolution of Examples 1 through 4 and Comparative Example and measured using a method illustrated in FIG. 9. The results are shown in Table 2 below.

Contrast Ratio Measurement Test

A filter 40 that included each of the optical sheets for high resolution of Examples 1 through 4 and Comparative Example and had a configuration illustrated in FIG. 2 was manufactured. The contrast ratio of each filter 40 was measured, and the results are shown in Table 2 below. Herein, a reinforced glass was used as a hard coating layer 400 of a filter base FB. In addition, each filter 40 was attached to a PDP module (Samsung SDI V4 42′ HD Module), and then the contrast ratio thereof was measured using a luminance measuring device (Minolta CS 1000, Samhee Instrument) at a distance of 1.5 m away from the filter in a bright room (150 Lux).

TABLE 2
Optical properties evaluation

| | Exam- | | Exam- | | Comparative |
|---|---|---|---|---|---|
| | ple 1 | Example 2 | ple 3 | Example 4 | Example |
| Δn | −0.01 | −0.01 | −0.01 | −0.01 | 0.01 |
| Transmittance | 72.4 | 67.6 | 70.1 | 68.6 | 67.1 |
| (%) | | | | | |
| Contrast | 400:1 | 340:1 | 370:1 | 350:1 | 310:1 |
| ratio | | | | | |
| Ghost image | Good | Good | Good | Good | So-so |
| Comprehensive | Good | Good | Good | Good | So-so |
| evaluation | | | | | |

Referring to Table 2, the filters including the optical sheets for high resolution of Examples 1 through 4 had improved optical properties in terms of transmittance, contrast ratio and a degree of generation of ghost images, as compared with the filter including the optical sheet for high resolution of Comparative Example. In particular, the external light absorption unit having a rectangular shape of Example 1 had the best optical properties. More particularly, as compared with the optical sheet for high resolution of Comparative Example where the refractive index of the light transmission unit was conventionally higher than that of the external light absorption unit, the light transmittance of the optical sheet for high resolution of the present invention where the refractive index of the light transmission unit was smaller than that of the external light absorption unit was not decreased even when a part of an image light was absorbed into the external light absorption unit. Rather, it was confirmed that the optical sheet for high resolution of Example 1 had more improved light transmittance by appropriate pattern design.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An optical sheet for high resolution comprising:
a plurality of external light absorption units that are disposed separate from each other at a predetermined interval and comprise a light absorbing material; and a plurality of light transmission units optically separated from each other by the external light absorption units,
wherein the refractive index of the light transmission unit is smaller than the refractive index of the external light absorption unit.

2. The optical sheet for high resolution of claim 1, wherein the external light absorption unit has a polygonal cross-section that simultaneously satisfies the following conditions:
0.5 H_{R}=H₂₂₀≦0.95 H_{R} 1)
0.1 Wₚ=W₂₂₀≦0.4 Wₚ 2)
50 μm≦H_{R}−Wₚ≦160 μm 3)
50μm≦Wₚ≦200 μm 4)
where H₂₂₀ refers to the height of the external light absorption unit. W₂₂₀ refers to the width of one end of the external light absorption unit, H_{R} refers to the thickness of the light transmission unit, and Wₚ refers to a pitch of the light transmission unit.

3. The optical sheet for high resolution of claim 2, wherein the external light absorption unit has a trapezoidal cross-section that additionally satisfies the following condition:
0.15≦W′₂₂₀/W₂₂₀≦0.35. 5)
where W₂₂₀ and W′₂₂₀ respectively refers to the widths of one end and the other end of the external light absorption unit.

4. The optical sheet for high resolution of claim 2, wherein the external light absorption unit has a pentagonal cross-section that additionally satisfies the following condition:
2.0≦W_{220.max}/W₂₂₀≦3.0. 5)
where W₂₂₀ and W_{220.max} respectively refers to the width of one end of the external light absorption unit and the maximum width of the external light absorption unit.

5. The optical sheet for high resolution of claim 1, wherein the external light absorption unit is disposed in a stripe form, matrix form, or wave form.

6. The optical sheet for high resolution of claim 1, further comprising a prism unit disposed on a surface of the light transmission unit, facing an image light source.

7. The optical sheet for high resolution of claim 1 wherein a longitudinal direction of the external light absorption unit is not parallel to a side of the optical sheet for high resolution.

8. A filter for a display device, comprising the optical sheet for high resolution according to claim 1, and a filter base.

9. The filter of claim 8, wherein the filter base comprises a reflection prevention film, a hard coating layer, an electromagnetic blocking film, or a combined layer thereof.

10. The filter of claim 9, further comprising a color adjustment film disposed on a light emission surface side of an image light source of the optical sheet for high resolution.

11. An image display device comprising the optical sheet for high resolution according to claim 1.

12. An image display device comprising the filter according to claim 8.
